(19) United States
(12) Patent Application Publication
(10) Pub. No.: US 2023/0403270 A1
(43) Pub. Date: Dec. 14, 2023

(54) SYSTEM AND METHOD FOR DYNAMIC USER AUTHENTICATION

(71) Applicant: Bank of America Corporation, Charlotte, NC (US)

(72) Inventors: Jinyoung N. Kim, Charlotte, NC (US); James T. MacAulay, Erie, CO (US); Lauren J. Alibey, Charlotte, NC (US); Serge A. Neri, Charlotte, NC (US); Brandon Sloane, Indian Land, SC (US); Sophie M. Danielpour, Durham, NC (US)

(21) Appl. No.: 17/839,155

(22) Filed: Jun. 13, 2022

(51) Int. Cl. H04L 9/40

(52) U.S. Cl. CPC H04L 63/0861

(57) ABSTRACT

An apparatus for dynamic user authentication comprises a processor associated with a server. The processor is configured to receive session data associated with a first user, wherein the session data comprises user parameters for a session and to receive an interaction request to authorize an interaction of a first avatar associated with the first user in a virtual environment. The processor is further configured to compare the user parameters of the session data to user parameters of a stored user profile and to authorize the interaction in response to comparing the session data to the stored user profile if a confidence threshold is satisfied. The processor is further configured to train the machine learning algorithm with the received session data to update the user profile, wherein updating the user profile improves information security by authenticating that the first user is authorized to interact via the first avatar.

### TECHNICAL FIELD

The present disclosure relates generally to network communications and information security. More particularly, in certain embodiments, the present disclosure is related to a system and method for dynamic user authentication.

### BACKGROUND

In a network environment, user devices are in data communication with other user devices that may be distributed anywhere in the world. These network environments allow data and information to be shared among these devices. Some of the technical challenges that occur when data is exchanged between devices are controlling data leakage, unauthorized access to data, and preventing malicious activities. Data storing user devices, such as computers, laptops, augmented reality devices, virtual reality devices, and smartphones, are vulnerable to attacks. This vulnerability poses several network security challenges. Existing systems are typically unable to detect a malicious attack until after the attack has occurred. For example, a bad actor may be unauthorized to access a file of a user and may proceed to conduct interactions as that user within a virtual environment. Due to the virtual environment, it can be challenging to identify social and physical behaviors of the user in view of a real-world environment. There may be an increase in social engineering as manipulating an avatar in the virtual environment can imply that the user is the authorized user associated with that avatar, thereby producing a false sense of security.

### SUMMARY

The disclosed system provides several practical applications and technical advantages that overcome the previously discussed technical problems. The following disclosure provides a practical application of a server that is configured as an information security device for a virtual environment. The disclosed information security device provides practical applications that improve the information security of the virtual environment by authenticating a user operating an avatar as the user associated with that avatar. Authentication of the user occurs by monitoring a user profile and iteratively re-training a machine learning algorithm with additional data. This process provides a technical advantage that increases information security because it inhibits a bad actor from conducting interactions as an avatar associated with another user in the virtual environment. This process may be employed to authenticate and validate the user before allowing the user to perform an interaction with another avatar or virtual object within a virtual environment.

In an embodiment, an apparatus for dynamic user authentication comprises a memory and a processor. The memory is operable to store a user profile associated with a first user in a file, wherein the user profile is created through a machine learning algorithm and comprises user parameters associated with the first user, wherein the user parameters are determined through an enrollment procedure comprising receiving training data to establish the user profile. The user parameters are categorized as static parameters (for example, measurements corresponding to a user profile), dynamic parameters (for example, measurements corresponding to motion behavior of one or more motions), and sequence parameters. The processor is operably coupled to the memory and configured to receive session data associated with the first user, wherein the session data comprises user parameters for a session. The processor is further configured to receive an interaction request to authorize an interaction of a first avatar associated with the first user in a virtual environment, wherein the interaction is between the first avatar and a second avatar or a virtual object. The processor is further configured to compare the user parameters of the session data to the user parameters of the stored user profile to satisfy a minimum percentage difference and to authorize the interaction in response to comparing the session data to the stored user profile if a confidence threshold is satisfied, wherein the confidence threshold is satisfied by a minimum number of user parameters of the session data satisfying the minimum percentage difference. The processor is further configured to train the machine learning algorithm with the received session data to update the user profile, wherein updating the user profile improves information security by authenticating that the first user is authorized to interact via the first avatar.

The disclosed system may further be integrated into an additional practical application of improving underlying operations of computing systems tasked to initiate and conduct interaction sessions with one or more users. For example, the disclosed system may reduce processing, memory, and time resources of a user device for identifying and validating a user associated with an avatar for each potential interaction. A separate server may analyze and monitor a user profile to authenticate the user and then may authorize an interaction session based on the authentication.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example system for dynamic user authentication;

FIG. 2 is a block diagram of an example user device of the system of FIG. 1;

FIG. 3 is a flow diagram illustrating an example operation of the system of FIG. 1;

and

FIG. 4 is a flow diagram illustrating an example operation of the system of FIG. 1.

### DETAILED DESCRIPTION

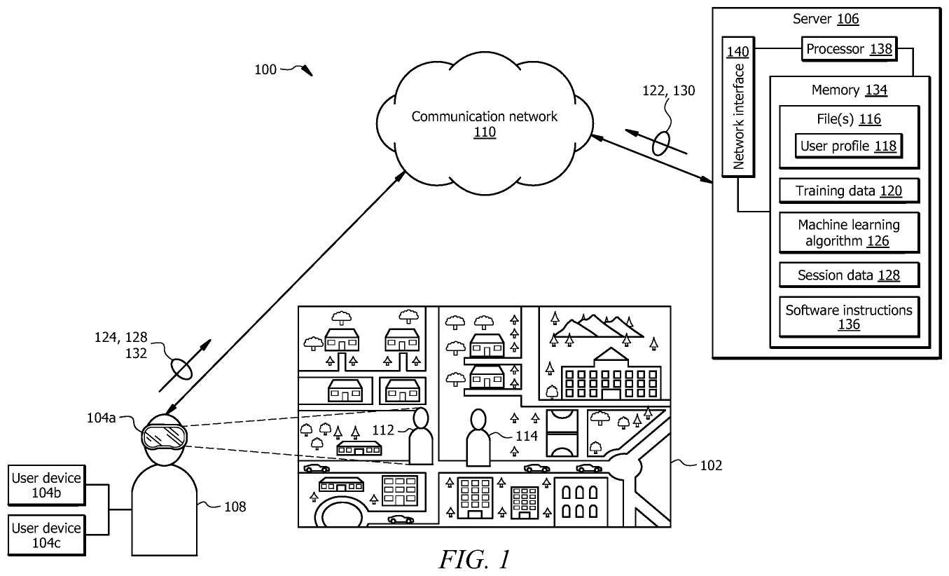

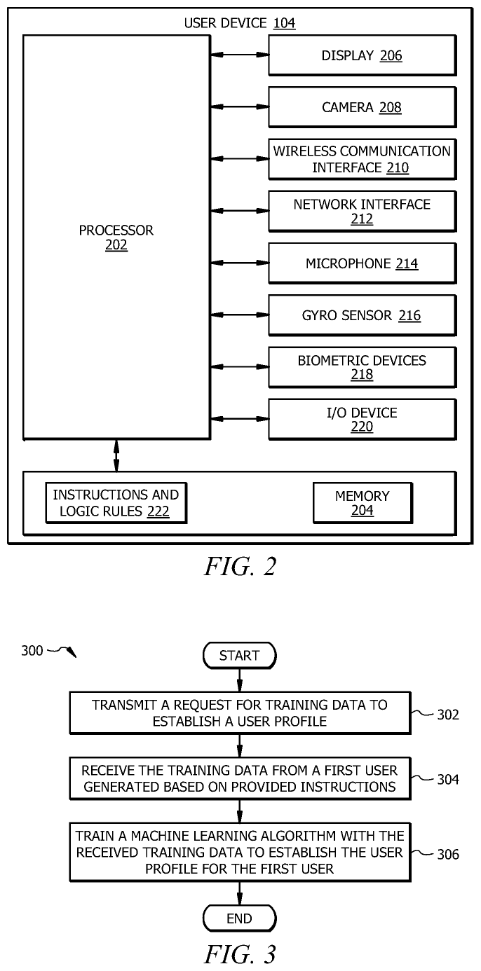

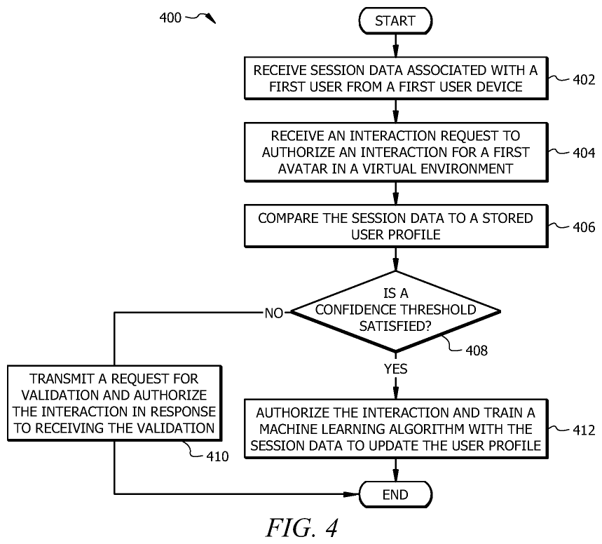

This disclosure provides solutions to the aforementioned and other problems of previous technology by dynamically authenticating a user for an interaction in a virtual environment. FIG. 1 is a schematic diagram of an example system for dynamic user authentication. FIG. 2 is a block diagram of an example user device of the system of FIG. 1. FIG. 3 is a flow diagram illustrating an example operation of the system of FIG. 1. FIG. 4 is a flow diagram illustrating an example operation of the system of FIG. 1.

### Example System for Dynamic User Authentication

FIG. 1 illustrates a schematic diagram of an example system 100 that is generally configured to dynamically authenticate a user for an interaction in a virtual environment 102. The system 100 may include a first user device 104a, a second user device 104b, a third user device 104c, and a server 106. A first user 108 is associated with the first, second, and third user devices 104a, 104b, and 104c (collectively referred to herein as “the plurality of user devices 104”). The system 100 may be communicatively coupled to a communication network 110 and may be operable to transmit data between the plurality of user devices 104 and the server 106 through the communication network 110. In general, the system 100 may improve electronic interaction technologies by authenticating that the first user 108 is associated with a first avatar 112 prior to an interaction between the first user 108 with a second user and/or with a virtual object in the virtual environment 102. This process provides improved information security because it validates that the first avatar 112 is not associated with a fraudulent user or entity prior to authorizing an interaction between the first user 108, via the first avatar 112, and a second user and/or with a virtual object.

For example, in a particular embodiment, a user (for example, the first user 108) may attempt to interact with a second user and/or with a virtual object in the virtual environment 102. The first user 108 may access the virtual environment 102 through the plurality of user devices 104. For example, the first user device 104a may be a wearable device (e.g., glasses or a headset), and the second and third user devices 104b, 104c may be hand-held controllers. The first user device 104a may be configured to display the virtual environment 102, and the second and third user devices 104b, 104c may be configured to control movement of the first avatar 112 in the virtual environment 102. The first user device 104a is configured to display a two-dimensional (2D) or three-dimensional (3D) representation of the virtual environment 102 to the first user 108. Examples of a virtual environment 102 may include, but are not limited to, a graphical or virtual representation of a metaverse, a map, a building interior, a landscape, a fictional location, an alternate reality, or any other suitable type of location or environment. The virtual environment 102 may be configured to use realistic or non-realistic physics for the motion of objects within the virtual environment 102. For example, some virtual environments 102 may be configured to use gravity whereas other virtual environments 102 may not be configured to use gravity.

Within the virtual environment 102, each user may be associated with an avatar (such as the first avatar 112 for the first user 108). An avatar is a graphical representation of the user at a virtual location within the virtual environment 102. Examples of an avatar may include, but are not limited to, a person, an animal, or an object. In some embodiments, the features and characteristics of the avatar may be customizable and user-defined. For example, the size, shape, color, attire, accessories, or any other suitable type of appearance features may be specified by a user. In embodiments, the virtual location of the avatar may be correlated to a physical location of a user in a real-world environment. By using an avatar, a user is able to move within the virtual environment 102 to interact with another avatar and objects within the virtual environment 102 while independently remaining at the physical location or being in transit in the real-world environment.

While engaging in the virtual environment 102 via the first avatar 112, the first user 108 may attempt to interact with a plurality of other users through a respective avatar or with a virtual object. For example, a second user may attempt to engage in an interaction session with the first avatar 112 through a second avatar 114 associated with that user. In the real-world environment, the second user may be located at a distance away from the first user 108. The second user may access the virtual environment 102 through a respective user device to control the second avatar 114 and attempt to engage in an interaction session with the first user 108 through the first avatar 112. In another example, the first user 108 may attempt to engage in an interaction session with a virtual object, through the first avatar 112, to exchange virtual resources and/or real-world resources. Before the interaction between the first avatar 112 and the second avatar 114 and/or virtual object occurs, the server 106 may authenticate that the first avatar 112 is associated with the first user 108 and not some fraudulent third-party. For example, the first user 108 may be required to sign into a file 116 associated with the first user 108, that is stored and managed by the server 106, in order to access the virtual environment 102 through the plurality of user devices 104. In embodiments, the server 106 may employ single sign-on (SSO), multifactor authentication, or any other suitable authentication scheme in order to allow the first user 108 access to the file 116. The file 116 may comprise user profile information, account information, avatar information, digital assets information, or any other suitable type of information that is associated with a user within the virtual environment 102 and/or the real-world environment.

As the first user 108 initially creates the file 116, the server 106 may create a user profile 118 associated with the first user 108 to be stored in the file 116. Each time the file 116 is accessed, the server 106 may monitor a user accessing the file 116 to verify that the user is the first user 108 and not a fraudulent third-party. In embodiments, the server 106 may continuously monitor the user when the file 116 is accessed. Verification may occur by comparing the created user profile 118 to static and/or dynamic measurements of the user. The server 106 may employ an enrollment procedure to determine user parameters within the user profile 118, wherein the enrollment procedure comprises receiving training data 120 to be stored within the user parameters for establishing the user profile 118. In one or more embodiments, user parameters may include static parameters, dynamic parameters, and sequence parameters (each described further below). For example, the server 106 may transmit a signal 122 requesting the training data 120 from the plurality of user devices 104. The plurality of user devices 104 may receive the signal 122 and transmit a reply signal 124 comprising one or more measurements determined by the plurality of user devices 104 as the requested training data 120. In embodiments, the signal 122 may comprise instructions to be performed by the first user 108 to produce the training data 120. Upon receiving the signal 122, the first user 108 may perform the received instructions, and the plurality of user devices 104 may determine the one or more measurements associated with the first user 108.

The one or more measurements may be categorized as static parameters, dynamic parameters, and sequence parameters within the user parameters of user profile 118. In embodiments, the static parameters may be physical measurements associated with the first user 108 in one or more static positions. For example, the static parameters may include the relative position of one of the plurality of user devices 104 with another one of the plurality of user devices 104, such as a distance between the first user device 104a and the second user device 104b, a distance between the first user device 104a and the third user device 104c, a distance between the second user device 104b and the third user device 104c, an angle or tilt of each of the plurality of user devices 104, approximate body dimension of the first user 108, and the like for one or more static positions. For example, a first static position may be where both hands of the first user 108 grasping the second and third user devices 104b,c are extended horizontally away from the body, and a second static position may be where both hands are resting along the sides of the body of the first user 108.

In embodiments, the dynamic parameters may be measurements associated with the first user 108 during one or more dynamic motions. For example, the dynamic parameters may include the speed, acceleration, change in angle or tilt, maximum and minimum distance values for a given motion, and the like for each of the one or more plurality of user devices 104 during a dynamic motion. In examples, the dynamic motions may include the first user 108 nodding a head, wherein the first user device 104a is coupled to the head, raising an arm, wherein either the second or third user device 104b,c is coupled to that arm, and the like. In embodiments, the sequence parameters may be a collective plurality of dynamic motions and may perform similar measurements as the dynamic parameters. The sequence parameters may include dynamic motions the first user 108 may enact while engaging in the virtual environment 102. For example, the collective plurality of dynamic motions categorized as a sequence parameter may include a door-opening motion, a walking motion, a sitting motion, and the like.

Upon receiving the signal 124, the server 106 may train a machine learning algorithm 126 with the received training data 120 to establish the user profile 118. Machine learning algorithm 126 may be configured to generate the user profile 118 in any suitable manner. For example, in certain embodiments, machine learning algorithm 126 may be trained to generate user profile 118 based on the measurements collected from components of system 100. Such measurements may include the static parameters, dynamic parameters, sequence parameters, and/or any other suitable parameters. Machine learning algorithm 126 may be trained to identify patterns within the measurements transmitted as the training data, which it may leverage to generate the user profile 118.

In certain embodiments, server 106 may be configured to update machine learning algorithm 126 based on usage of the file 116 associated with the first user 108. For example, server 106 may be configured to receive session data 128 associated with one or more measurements determined of a user controlling the first avatar 112 in the virtual environment 102 and compare the session data 128 to the user profile 118. The session data 128 may comprise the same or similar one or more measurements determined by the plurality of user devices 104 used to create user profile 118 (for example, as user parameters categorized as static parameters, dynamic parameters, and sequence parameters). For example, the session data 128 may include one or more measurements of the relative position of one of the plurality of user devices 104 with another one of the plurality of user devices 104, an angle or tilt of each of the plurality of user devices 104, speed of one of the plurality of user devices 104 during a motion, acceleration of one of the plurality of user devices 104 during a motion, change in angle or tilt of one of the plurality of user devices 104 during a motion, maximum and minimum distance values for one of the plurality of user devices 104 during a motion, and the like. The server 106 may receive session data 128 each time the file 116 is accessed or being accessed to operate the first avatar 112. With reference to the present disclosure, each time the file 116 is accessed may be referred to as a “session”, and the server 106 may receive data associated with that session for comparison (for example, the session data 128). Server 106 may then be configured to retrain machine learning algorithm 126 based on differences between the session data 128 and the user profile 118.

Machine learning algorithm 126 may be any suitable machine learning algorithm capable of generating and monitoring the user profile 118. For example, in certain embodiments, machine learning algorithm 126 may correspond to a neural network machine learning algorithm. In some embodiments, machine learning algorithm 126 may be a naïve bayes algorithm, a nearest neighbor algorithm, a support vector machine, and/or any other suitable machine learning algorithm trained to generate and monitor the user profile 118. Furthermore, while machine learning algorithm 126 may be a supervised machine learning algorithm trained using labeled data, as described above, this disclosure also contemplates that machine learning algorithm 126 may be an unsupervised machine learning algorithm, a semi-supervised learning algorithm, or a reinforcement learning algorithm.

In embodiments, the server 106 may continuously receive session data 128 from the plurality of user devices 104 as a user, such as the first user 108, interacts within the virtual environment 102 via the first avatar 112. The server 106 may update the user profile 118 by retraining the machine learning algorithm 126 with the received session data 128. In other embodiments, the server 106 may determine that the differences between the session data 128 and user profile 118 are greater than a threshold value. As previously described above, the server 106 may authenticate that the first avatar 112 is associated with the first user 108 and not some fraudulent third-party. For authentication, the server 106 may compare the session data 128 to the user profile 118 to satisfy a minimum percentage difference of the one or more measurements of the session data 128 corresponding to the user parameters in the user profile 118. For example, the minimum percentage difference may be about 85%. In other embodiments, the minimum percentage difference may be any other suitable value greater than or less than 85%.

In an example, the user profile 118 for the first user 108 has been generated and comprises user parameters categorized as static parameters, dynamic parameters, and sequence parameters. As previously described, these user parameters may be determined by the server 106 receiving one or more measurements from the plurality of user devices 104 during an enrollment procedure. Each time a user accesses file 116 to engage in the virtual environment 102 with the plurality of user devices 104, the server 106 may receive session data 128 from the plurality of user devices 104. The session data 128 may comprise one or more measurements determined by the plurality of user devices 104 during that session, wherein the one or more measurements are also categorized as static parameters, dynamic parameters, or sequence parameters. To authenticate the user accessing the file 116 as the first user 108, the server 106 may compare the received session data 128 to the user profile 118 to satisfy the minimum percentage difference of values.

For example, the session data 128 may comprise a measurement of a distance of four feet between the second user device 104b and the third user device 104c, where the user is in a first static position where both hands grasping user devices 104b,c are extended horizontally away from the body. The session data 128 may further comprise a measurement of a distance of one foot between the second user device 104b and the third user device 104c, where the user is in a second static position where both hands grasping user devices 104b,c are resting along the sides of the body. In this example, the user profile 118 may comprise measurements of 3.9 feet and 1.1 feet for the same first and second static positions, respectively, of the first user 108. The server 106 may determine that both measurements for the first and second static positions of the user for the session data 128 are greater than the minimum percentage difference (i.e., 85%). For example, the percentage difference between the measurements for the first and second static positions of the user for the session data 128 and the user parameters in the user profile 118 is 97% and 91%, respectively. If a difference between a given measurement of the session data 128 and user parameter for the user profile 118 is greater than the minimum percentage difference, that measurement may be determined to correspond to the user parameter of the user profile 118. The value of the measurement does not have to be equivalent to or match the value of the user parameter exactly. For example, the measurement of the distance of four feet for the first static position is not equal to the value of the corresponding user parameter stored in the user profile 118 (i.e., 3.9 feet), but the difference between the measurement and user parameter in the user profile 118 is greater than the minimum percentage difference.

During operation, a confidence threshold may be applied to the collective measurements received as the session data 128 after satisfying the minimum percentage difference. For example, the confidence threshold may be about 95%. In other embodiments, the confidence threshold may be any other suitable value greater than or less than 95%. The confidence threshold may be applied to determine whether the differences between the collective session data 128 and the user profile 118 are sufficiently minimal to authenticate the user as the first user 108. For example, if the user parameters of the user profile 118 comprise fifty measurements categorized as one of static parameters, dynamic parameters, or sequence parameters and the confidence threshold is 95%, forty-eight measurements received as the session data 128 may be required to be greater than the minimum percentage difference of those respective values to satisfy the confidence threshold.

If the confidence threshold is satisfied, the server 106 may authorize an interaction request to authorize an interaction between the first avatar 112 and the second avatar 114 or a virtual object in the virtual environment 102. The server 106 may further conduct the interaction between the first avatar 112 and the second avatar 114 or a virtual object after authenticating the first user 108 through comparing the session data 128 to the user profile 118 generated and maintained through the machine learning algorithm 126. The interaction may comprise the exchange of virtual resources and/or real-world resources.

In other embodiments, the server 106 may determine that the confidence threshold has not been satisfied through comparison of the session data 128 and user profile 118. The server 106 may transmit a request 130 for validation to the plurality of user devices 104 operated by the user. The user may perform an action aligned with instructions provided by the request 130, such as providing documentation associated with the first user 108 or performing one or more motions, to validate that the user is the first user 108. The plurality of user devices 104 may transmit a response signal 132 comprising a reply to request 130. In response to receiving the response signal 132, the server 106 may authenticate the user as the first user 108 and authorize the interaction. In these embodiments, the first user 108 may be operating the plurality of user devices 104 differently from the stored user profile 118. For example, the first user 108 may be operating the second user device 104b and/or the third user device 104c with an injury affecting motions categorized under the dynamic parameters and/or affecting physical measurements categorized under static parameters. In this example, the server 106 may receive session data 128 as the first user 108 is accessing file 116 to engage in the virtual environment 102 and determine that the confidence threshold is not satisfied during the comparison of the session data 128 to the user profile 118. The first user 108 may undergo this secondary authentication process to continue to interact in the virtual environment 102. In these embodiments, the user profile 118 may be updated through retraining the machine learning algorithm 126 to qualify that session data 128 as being associated with the first user 108.

The server 106 is generally a suitable server (e.g., including a physical server and/or virtual server) operable to store data in a memory 134 and/or provide access to application(s) or other services. The server 106 may be a backend server associated with a particular group that facilitates conducting interactions between entities and one or more users. Details of the operations of the server 106 are described in conjunction with FIGS. 3-4. Memory 134 includes software instructions 136 that, when executed by a processor 138, cause the server 106 to perform one or more functions described herein. Memory 134 may be volatile or non-volatile and may comprise a read-only memory (ROM), random-access memory (RAM), ternary content-addressable memory (TCAM), dynamic random-access memory (DRAM), and static random-access memory (SRAM). Memory 134 may be implemented using one or more disks, tape drives, solid-state drives, and/or the like. Memory 134 is operable to store software instructions 136, file(s) 116, session data 128, machine learning algorithm 126, training data 120, and/or any other data or instructions. The software instructions 136 may comprise any suitable set of instructions, logic, rules, or code operable to execute the processor 138. In these examples, the processor 138 may be communicatively coupled to the memory 134 and may access the memory 134 for these determinations.

Processor 138 comprises one or more processors operably coupled to the memory 134. The processor 138 is any electronic circuitry including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 138 can include any suitable data generation engine modules. The processor 138 may be a programmable logic device, a microcontroller, a microprocessor, or any suitable combination of the preceding. The one or more processors are configured to process data and may be implemented in hardware or software. For example, the processor 138 may be 8-bit, 16-bit, 32-bit, 64-bit, or of any other suitable architecture. The processor 138 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 136. In this way, processor 138 may be a special-purpose computer designed to implement the functions disclosed herein. In an embodiment, the processor 138 is implemented using logic units, FPGAs, ASICs, DSPs, or any other suitable hardware. The processor 138 is configured to operate as described in FIGS. 1 and 3-4. For example, the processor 138 may be configured to perform the steps of method 300 as described in FIG. 3 and the steps of method 400 as described in FIG. 4.

As illustrated, the server 106 may further comprise a network interface 140. Network interface 140 is configured to enable wired and/or wireless communications (e.g., via communication network 110). The network interface 140 is configured to communicate data between the server 106 and other devices (e.g., first user device 104a, second user device 104b, third user device 104c, etc.), databases, systems, or domain(s). For example, the network interface 140 may comprise a WIFI interface, a local area network (LAN) interface, a wide area network (WAN) interface, a modem, a switch, or a router. The processor 138 is configured to send and receive data using the network interface 140. The network interface 140 may be configured to use any suitable type of communication protocol as would be appreciated by one of skill in the art.

The communication network 110 may facilitate communication within the system 100. This disclosure contemplates the communication network 110 being any suitable network operable to facilitate communication between the first user device 104a, second user device 104b, third user device 104c, and the server 106. Communication network 110 may include any interconnecting system capable of transmitting audio, video, signals, data, messages, or any combination of the preceding. Communication network 110 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a POT network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system 100. In other embodiments, system 100 may not have all of these components and/or may have other elements instead of, or in addition to, those above.

Each of the plurality of user devices 104 (i.e., first user device 104a, second user device 104b, and third user device 104c) may be any computing device configured to communicate with other devices, such as a server (e.g., server 106), databases, etc. through the communication network 110. Each of the user devices 104 may be configured to perform specific functions described herein and interact with server 106, e.g., via user interfaces. The user devices 104 are each a hardware device that is generally configured to provide hardware and software resources to a user. Examples of a user device include, but are not limited to, a virtual reality device, an augmented reality device, a laptop, a computer, a smartphone, a tablet, a smart device, a hand-held controller, an Internet-of-Things (IoT) device, or any other suitable type of device. The user device may comprise a graphical user interface (e.g., a display), a touchscreen, a touchpad, keys, buttons, a mouse, or any other suitable type of hardware that allows a user to view data and/or to provide inputs into the user device. Each of the user devices 104 may be configured to allow a user to send requests to the server 106 or to another user device.

### Example User Device

FIG. 2 is a block diagram of an embodiment of one of the plurality of user devices 104 used by the system of FIG. 1. Any one of the user devices 104 may be configured to display the virtual environment 102 (referring to FIG. 1) within a field of view of the first user 108 (referring to FIG. 1), capture biometric, sensory, and/or physical information of the first user 108 wearing the user device 104, and to facilitate an electronic interaction with the first user 108 in the virtual environment. An example of the user device 104 in operation is described in FIG. 4.

Each of the user devices 104 comprises a processor 202 and a memory 204. In embodiments, at least one of the user devices 104 further comprises a display 206. Further embodiments may include a camera 208, a wireless communication interface 210, a network interface 212, a microphone 214, a gyro sensor 216, one or more biometric devices 218, and an input/output (I/O) device 220. Each of the user devices 104 may be configured as shown or in any other suitable configuration. For example, any one of the user devices 104 may comprise one or more additional components and/or one or more shown components may be omitted.

The processor 202 comprises one or more processors operably coupled to and in signal communication with memory 204, display 206, camera 208, wireless communication interface 210, network interface 212, microphone 214, gyro sensor 216, biometric devices 218, and I/O device 220. Processor 202 is configured to receive and transmit electrical signals among one or more of memory 204, display 206, camera 208, wireless communication interface 210, network interface 212, microphone 214, gyro sensor 216, biometric devices 218, and I/O device 220. The electrical signals are used to send and receive data (e.g., images captured from camera 208, virtual objects to display on display 206, etc.) and/or to control or communicate with other devices. Processor 202 may be operably coupled to one or more other devices (for example, the server 106 in FIG. 1).

The processor 202 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 202 may be a programmable logic device, a microcontroller, a microprocessor, or any suitable combination of the preceding. The one or more processors are configured to process data and may be implemented in hardware or software. For example, the processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions to implement the function disclosed herein, such as some or all of those described with respect to FIGS. 1 and 4. For example, processor 202 may be configured to display virtual objects on display 206, detect hand gestures, identify virtual objects selected by a detected hand gesture (e.g., identify selected files), capture biometric information of a user, such as first user 108, via one or more of camera 208, microphone 214, and/or biometric devices 218, and communicate via wireless communication interface 210 with server 106. In some embodiments, the function described herein is implemented using logic units, FPGAs, ASICs, DSPs, or any other suitable hardware or electronic circuitry.

The memory 204 is operable to store any of the information described with respect to FIGS. 1 and 4 along with any other data, instructions, logic, rules, or code operable to implement the function(s) described herein when executed by processor 202. For example, the memory 204 may store the instructions and logic rules 222, which are described below with respect to FIG. 4. The memory 204 comprises one or more disks, tape drives, or solid-state drives, and may be used as an over-flow data storage device, to store programs when such programs are selected for execution, and to store instructions and data that are read during program execution. Memory 204 is operable to store, for example, instructions for performing the functions of user device 104 described herein, and any other data or instructions. The memory 204 may be volatile or non-volatile and may comprise read-only memory (ROM), random-access memory (RAM), ternary content-addressable memory (TCAM), dynamic random-access memory (DRAM), and static random-access memory (SRAM).

Display 206 is configured to present visual information to a user (for example, first user 108 in FIG. 1) in an augmented reality environment that overlays virtual or graphical objects onto tangible objects in a real scene in real-time. In other embodiments, the display 206 is configured to present visual information to the user as the virtual environment 102 (referring to FIG. 1) in real-time. In an embodiment, display 206 is a wearable optical display (e.g., glasses or a headset) configured to reflect projected images and enables a user to see through the display. For example, display 206 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matrix OLED (AMOLED), an organic LED (OLED) display, a projector display, or any other suitable type of display as would be appreciated by one of ordinary skill in the art upon viewing this disclosure. In another embodiment, display 206 is a graphical display on a user device. For example, the graphical display may be the display of a tablet or smart phone configured to display an augmented reality environment with virtual or graphical objects onto tangible objects in a real scene in real-time and/or virtual environment 102.

Examples of camera 208 include, but are not limited to, charge-coupled device (CCD) cameras and complementary metal-oxide semiconductor (CMOS) cameras. Camera 208 is configured to capture images of a wearer of user device 104, such as first user 108. Camera 208 may be configured to capture images continuously, at predetermined intervals, or on-demand. For example, camera 208 may be configured to receive a command from first user 108 to capture an image. In another example, camera 208 is configured to continuously capture images to form a video stream. Camera 208 is communicably coupled to processor 202.

Examples of wireless communication interface 210 include, but are not limited to, a Bluetooth interface, an RFID interface, a near field communication interface, a local area network (LAN) interface, a personal area network interface, a wide area network (WAN) interface, a Wi-Fi interface, a ZigBee interface, or any other suitable wireless communication interface as would be appreciated by one of ordinary skill in the art upon viewing this disclosure. Wireless communication interface 210 is configured to facilitate processor 202 in communicating with other devices. For example, wireless communication interface 210 is configured to enable processor 202 to send and receive signals with other devices, such as server 106 (referring to FIG. 1). Wireless communication interface 210 is configured to employ any suitable communication protocol.

The network interface 212 is configured to enable wired and/or wireless communications. The network interface 212 is configured to communicate data between the user device 104 and other network devices, systems, or domain(s). For example, the network interface 212 may comprise a WIFI interface, a local area network (LAN) interface, a wide area network (WAN) interface, a modem, a switch, or a router. The processor 202 is configured to send and receive data using the network interface 212. The network interface 212 may be configured to use any suitable type of communication protocol as would be appreciated by one of ordinary skill in the art.

Microphone 214 is configured to capture audio signals (e.g., voice signals or commands) from a user, such as first user 108. Microphone 214 is configured to capture audio signals continuously, at predetermined intervals, or on-demand. Microphone 214 is communicably coupled to processor 202.

Gyro sensor 216 is configured to measure and/or maintain orientation and angular velocity. For example, gyro sensor 216 may measure an orientation of the user device 104 and an angular velocity of the user device 104 during a motion. Gyro sensor 216 may be used in conjunction with a proximity sensor operable to detect the presence of nearby objects without physical contact. In embodiments, the proximity sensor may be incorporated into the wireless communication interface 210. Gyro sensor 216 is communicably coupled to processor 202.

Examples of biometric devices 218 may include, but are not limited to, retina scanners and fingerprint scanners. Biometric devices 218 are configured to capture information about a person's physical characteristics and to output a biometric signal based on captured information. A biometric signal is a signal that is uniquely linked to a person based on their physical characteristics. For example, biometric device 218 may be configured to perform a retinal scan of the user's eye and to generate a biometric signal for the user based on the retinal scan. As another example, a biometric device 218 is configured to perform a fingerprint scan of the user's finger and to generate a biometric signal for the user based on the fingerprint scan. Biometric device 218 is communicably coupled to processor 202.

I/O device 220 is configured to enable communication between a user and user device 104. As an example and not by way of limitation, an I/O device 220 may include button(s), keyboard, keypad, microphone, monitor, mouse, stylus, tablet, touch screen, trackball, another suitable I/O device or a combination of two or more of these. An I/O device may include one or more sensors. This disclosure contemplates any suitable I/O devices and any suitable I/O interfaces for them. Where appropriate, I/O interface may include one or more device or software drivers enabling processor 202 to drive one or more of these I/O devices. I/O device 220 is communicably coupled to processor 202.

### Example Operations of the System for Dynamic User Authentication

FIG. 3 is a flow diagram illustrating an example method 300 of the system 100 of FIG. 1. The method 300 may be implemented using the plurality of user devices 104 and the server 106 of FIG. 1 for an enrollment procedure of the first user 108 (referring to FIG. 1). The enrollment procedure may occur as the first user 108 creates the file 116 (referring to FIG. 1) to access the virtual environment 102 (referring to FIG. 1). For example, a user, such as first user 108, may be required to sign into the file 116, that is stored and managed by the server 106, in order to access the virtual environment 102 through the plurality of user devices 104. In embodiments, the server 106 may employ single sign-on (SSO), multifactor authentication, or any other suitable authentication scheme in order to allow the first user 108 access to the file 116. The file 116 may comprise user profile information, account information, avatar information, digital assets information, or any other suitable type of information that is associated with a user within the virtual environment 102 and/or the real-world environment. As the first user 108 initially creates the file 116, the server 106 may create a user profile 118 (referring to FIG. 1) associated with the first user 108 to be stored in the file 116. Each time the file 116 is accessed, the server 106 may monitor a user accessing the file 116 to verify that the user is the first user 108 and not a fraudulent third-party. In embodiments, the server 106 may continuously monitor the user when the file 116 is accessed. Verification may occur by comparing the created user profile 118 to static and/or dynamic measurements of the user.

The method 300 may begin at step 302 where the processor 138 (referring to FIG. 1) of the server 106 may transmit a request for training data 120 (referring to FIG. 1) to establish the user profile 118 through the enrollment procedure, wherein the user profile 118 is stored in the file 116. Within step 302, the processor 138 of the server 106 may transmit the signal 122 (referring to FIG. 1) requesting the training data 120 from the plurality of user devices 104.

At step 304, the plurality of user devices 104 may receive the signal 122 and transmit a reply signal 124 (referring to FIG. 1) comprising one or more measurements determined by the plurality of user devices 104 as the requested training data 120. In embodiments, the signal 122 may comprise instructions to be performed by the first user 108 to produce the training data 120. Upon receiving the signal 122, the first user 108 may perform the received instructions, and the plurality of user devices 104 may determine one or more measurements associated with the first user 108. The processor 138 of the server 106 may then receive the reply signal 124 comprising the requested training data 120.

At step 306, the processor 138 of the server 106 may train the machine learning algorithm 126 (referring to FIG. 1) with the received training data 120 to establish the user profile 118. Machine learning algorithm 126 may be configured to generate the user profile 118 in any suitable manner. For example, in certain embodiments, machine learning algorithm 126 may be trained to generate user profile 118 based on the measurements collected from components of system 100 (i.e., the plurality of user devices 104). Such measurements may include the static parameters, dynamic parameters, sequence parameters, and/or any other suitable parameters. Machine learning algorithm 126 may be trained to identify patterns within the measurements transmitted as the training data 120, which it may leverage to generate the user profile 118. Once the user profile 118 has been generated, the method 300 may proceed to end.

FIG. 4 is a flow diagram illustrating an example method 400 of the system 100 of FIG. 1. The method 400 may be implemented using the plurality of user devices 104 and the server 106 of FIG. 1 for dynamic authentication of the first user 108 (referring to FIG. 1). The method 400 may begin at step 402 where the processor 138 (referring to FIG. 1) of the server 106 may receive session data 128 (referring to FIG. 1) from the plurality of user devices 104. In one or more embodiments, at least one of the plurality of user devices, such as the first user device 104a (referring to FIG. 1) may be in communication with the server 106. The processor 138 of the server 106 may receive session data 128 each time the file 116 (referring to FIG. 1) is accessed or being accessed to operate the first avatar 112 (referring to FIG. 1) within the virtual environment 102 (referring to FIG. 1). With reference to the present disclosure, each time the file 116 is accessed may be referred to as a “session”, and the server 106 may receive data associated with that session for comparison (for example, the session data 128) to the user profile 118 established through method 300 (referring to FIG. 3). In embodiments, the processor 138 of the server 106 may continuously receive session data 128 from the plurality of user devices 104 as a user, such as the first user 108, interacts within the virtual environment 102 via the first avatar 112.

At step 404, the first user 108 may request to establish an interaction session to conduct an interaction between the first avatar 112 and a second avatar 114 (referring to FIG. 1) or a virtual object in the virtual environment 102. In embodiments, the processor 138 of the server 106 may receive an interaction request to authorize said interaction. Before the interaction between the first avatar 112 and the second avatar 114 or virtual object occurs, the processor 138 of the server 106 may authenticate the user of the first avatar 112 as the first user 108. For example, a bad actor may be unauthorized to access file 116 associated with first user 108 and may proceed to conduct interactions as the first user 108 within the virtual environment 102.

At step 406, the processor 138 of the server 106 may compare the received session data 128 from step 402 to the user profile 118 of the file 116. For example, a user may generate session data 128 while interacting as the first avatar 112 in the virtual environment 102. The processor 138 of the server 106 may receive the session data 128 and compare the user parameters of the session data 128 to those of the user profile 118. In embodiments, these user parameters may include one or more measurements produced by the plurality of user devices 104 categorized as static parameters, dynamic parameters, and sequence parameters. The processor 138 of the server 106 may compare the session data 128 to the user profile 118 to satisfy a minimum percentage difference of the one or more measurements of the session data 128 corresponding to the user parameters in the user profile 118. For example, the minimum percentage difference may be about 85%.

In an example, the session data 128 may comprise a measurement of a distance of four feet between the second user device 104b and the third user device 104c, where the user is in a first static position where both hands grasping user devices 104b,c are extended horizontally away from the body. The session data 128 may further comprise a measurement of a distance of one foot between the second user device 104b and the third user device 104c, where the user is in a second static position where both hands grasping user devices 104b,c are resting along the sides of the body. In this example, the user profile 118 may comprise measurements of 3.9 feet and 1.1 feet for the same first and second static positions, respectively, of the first user 108. The processor 138 of the server 106 may determine that both measurements for the first and second static positions of the user for the session data 128 are greater than the minimum percentage difference (i.e., 85%). For example, the percentage difference between the measurements for the first and second static positions of the user for the session data 128 and the user parameters in the user profile 118 is 97% and 91%, respectively. If a difference between a given measurement of the session data 128 and user parameter for the user profile 118 is greater than the minimum percentage difference, that measurement may be determined to correspond to the user parameter of the user profile 118.

At step 408, the processor 138 of server 106 may determine whether a confidence threshold has been satisfied. The confidence threshold may be applied to the collective measurements received as the session data 128 after satisfying a minimum percentage difference. The confidence threshold may be applied to determine whether the differences between the session data 128 and the user profile 118 are sufficiently minimal to authenticate the user as the first user 108. For example, if the user parameters of the user profile 118 comprise fifty measurements categorized as one of static parameters, dynamic parameters, or sequence parameters and the confidence threshold is 95%, forty-eight measurements received as the session data 128 may be required to be greater than the minimum percentage difference of those respective values to satisfy the confidence threshold. In one or more embodiments, each of the user parameters (for example, the static, dynamic, and sequence parameters) may have individual confidence thresholds. In certain embodiments, each individual confidence threshold may require satisfaction prior to authorizing the interaction. In other embodiments, at least one individual confidence threshold is required to be satisfied to authorize the interaction. If the processor 138 determines that the confidence threshold is not satisfied, the method 400 proceeds to step 410. Otherwise, the method 400 proceeds to step 412.

At step 410, the processor 138 of server 106 may have determined that the confidence threshold has not been satisfied through comparison of the session data 128 and user profile 118 in step 408. The processor 138 of server 106 may transmit request 130 (referring to FIG. 1) for validation to the plurality of user devices 104 operated by the user. The user may perform an action aligned with instructions provided by the request 130, such as providing documentation associated with the first user 108 or performing one or more motions, to validate that the user is the first user 108. The plurality of user devices 104 may transmit response signal 132 (referring to FIG. 1) comprising a reply to request 130. In response to receiving the response signal 132, the processor 138 of server 106 may authenticate the user as the first user 108 and authorize the interaction. In these embodiments, the first user 108 may be operating the plurality of user devices 104 differently from the stored user profile 118. For example, the first user 108 may be operating the second user device 104b and/or the third user device 104c with an injury affecting motions categorized under the dynamic parameters and/or affecting physical measurements categorized under static parameters (for example, a broken arm). In this example, the processor 138 of server 106 may receive session data 128 as the first user 108 is accessing file 116 to engage in the virtual environment 102 and determine that the confidence threshold was not satisfied during the comparison of the session data 128 to the user profile 118. The first user 108 may undergo this secondary authentication process to continue to interact in the virtual environment 102. In these embodiments, the user profile 118 may be updated through retraining the machine learning algorithm 126 to qualify that session data 128 as being associated with the first user 10

At step 412, the processor 138 of server 106 may have determined that the confidence threshold has been satisfied through comparison of the session data 128 and user profile 118 in step 408. The processor 138 of server 106 may authorize an interaction request to authorize an interaction between the first avatar 112 and the second avatar 114 or a virtual object in the virtual environment 102. The server 106 may further conduct the interaction between the first avatar 112 and the second avatar 114 or a virtual object after authenticating the first user 108 through comparing the session data 128 to the user profile 118 generated and maintained through the machine learning algorithm 126. The interaction may comprise the exchange of virtual resources and/or real-world resources. The processor 138 of server 106 may then re-train the machine learning algorithm 126 with the received session data 128 from step 402 to update the user profile 118, wherein updating the user profile 118 improves information security by authenticating that the first user 108 is authorized to interact via the first avatar 112. Then, the method 300 proceeds to end.

While several embodiments have been provided in the present disclosure, it should be understood that the disclosed systems and methods might be embodied in many other specific forms without departing from the spirit or scope of the present disclosure. The present examples are to be considered as illustrative and not limiting, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 106(f) as it exists on the date of filing hereof unless the words “means for” or “step for” are explicitly used in the particular claim.

1. An apparatus for dynamic user authentication, comprising:
a memory operable to:
store a user profile associated with a first user in a file, wherein the user profile is created through a machine learning algorithm and comprises user parameters associated with the first user, wherein the user parameters are determined through an enrollment procedure comprising receiving training data to establish the user profile; and
a processor, operably coupled to the memory, configured to:
receive session data associated with the first user, wherein the session data comprises user parameters for a session;
receive an interaction request to authorize an interaction of a first avatar associated with the first user in a virtual environment, wherein the interaction is between the first avatar and a second avatar or a virtual object;
compare the user parameters of the session data to the user parameters of the stored user profile to satisfy a minimum percentage difference;
authorize the interaction in response to comparing the session data to the stored user profile if a confidence threshold is satisfied, wherein the confidence threshold is satisfied by a minimum number of user parameters of the session data satisfying the minimum percentage difference; and
train the machine learning algorithm with the received session data to update the user profile.

2. The apparatus of claim 1, wherein the processor is further configured to:
transmit a request for training data to establish the user profile through the enrollment procedure;
receive the training data from a first user device associated with the first user; and
train the machine learning algorithm with the received training data to establish the user profile.

3. The apparatus of claim 2, wherein the training data comprises static parameters, dynamic parameters, and sequence parameters.

4. The apparatus of claim 3, wherein the confidence threshold is associated with each one of the static parameters, the dynamic parameters, and the sequence parameters.

5. The apparatus of claim 2, wherein the processor is further configured to:
transmit an instruction to be performed by the first user for generating the training data.

6. The apparatus of claim 1, wherein the processor is further configured to:
determine that the confidence threshold is not satisfied;
transmit a request for validation to a first user device associated with the first user; and
authorize the interaction in response to receiving validation from the first user device.

7. The apparatus of claim 1, wherein the memory is further configured to:
update the user profile after the processor trains the machine learning algorithm with the received session data.

8. A method for dynamic user authentication, comprising:
receiving session data associated with a first user, wherein the session data comprises user parameters for a session;
receiving an interaction request to authorize an interaction of a first avatar associated with the first user in a virtual environment, wherein the interaction is between the first avatar and a second avatar or a virtual object;
comparing the user parameters of the session data to user parameters of a stored user profile to satisfy a minimum percentage difference, wherein the stored user profile is created through a machine learning algorithm and comprises user parameters associated with the first user, wherein the user parameters of the stored user profile are determined through an enrollment procedure comprising receiving training data to establish the user profile;
authorizing the interaction in response to comparing the session data to the stored user profile if a confidence threshold is satisfied, wherein the confidence threshold is satisfied by a minimum number of user parameters of the session data satisfying the minimum percentage difference; and
training the machine learning algorithm with the received session data to update the user profile.

9. The method of claim 8, further comprising:
transmitting a request for training data to establish the user profile through the enrollment procedure;
receiving the training data from a first user device associated with the first user; and
training the machine learning algorithm with the received training data to establish the user profile.

10. The method of claim 9, wherein the training data comprises static parameters, dynamic parameters, and sequence parameters.

11. The method of claim 10, wherein the confidence threshold is associated with each one of the static parameters, the dynamic parameters, and the sequence parameters.

12. The method of claim 9, further comprising:
transmitting an instruction to be performed by the first user for generating the training data.

13. The method of claim 8, further comprising:
determining that the confidence threshold is not satisfied;
transmitting a request for validation to a first user device associated with the first user; and
authorizing the interaction in response to receiving validation from the first user device.

14. The method of claim 8, further comprising:
updating the user profile after the processor trains the machine learning algorithm with the received session data.

15. A non-transitory computer-readable medium comprising instructions that are configured, when executed by a processor, to:
receive session data associated with a first user, wherein the session data comprises user parameters for a session;
receive an interaction request to authorize an interaction of a first avatar associated with the first user in a virtual environment, wherein the interaction is between the first avatar and a second avatar or a virtual object;
compare the user parameters of the session data to user parameters of a stored user profile to satisfy a minimum percentage difference, wherein the stored user profile is created through a machine learning algorithm and comprises user parameters associated with the first user, wherein the user parameters of the stored user profile are determined through an enrollment procedure comprising receiving training data to establish the user profile;
authorize the interaction in response to comparing the session data to the stored user profile if a confidence threshold is satisfied, wherein the confidence threshold is satisfied by a minimum number of user parameters of the session data satisfying the minimum percentage difference; and
train the machine learning algorithm with the received session data to update the user profile.

16. The non-transitory computer-readable medium of claim 15, wherein the instructions are further configured to:
transmit a request for training data to establish the user profile through the enrollment procedure;
receive the training data from a first user device associated with the first user; and
train the machine learning algorithm with the received training data to establish the user profile.

17. The non-transitory computer-readable medium of claim 16, wherein the training data comprises static parameters, dynamic parameters, and sequence parameters, and wherein the confidence threshold is associated with each one of the static parameters, the dynamic parameters, and the sequence parameters.

18. The non-transitory computer-readable medium of claim 16, wherein the instructions are further configured to:
transmit an instruction to be performed by the first user for generating the training data.

19. The non-transitory computer-readable medium of claim 15, wherein the instructions are further configured to:
determine that the confidence threshold is not satisfied;
transmit a request for validation to a first user device associated with the first user; and
authorize the interaction in response to receiving validation from the first user device.

20. The non-transitory computer-readable medium of claim 15, wherein the instructions are further configured to:
instruct a memory operably coupled to the processor to update the user profile after the processor trains the machine learning algorithm with the received session data.
